(19) United States
(12) Patent Application Publication
(10) Pub. No.: US 2015/0131460 A1
(43) Pub. Date: May 14, 2015

(54) METHOD AND APPARATUS FOR USING RSSI AND RTT INFORMATION FOR CHOOSING ACCESS POINTS TO ASSOCIATE WITH

(71) Applicant: QUALCOMM Incorporated, San Diego, CA (US)

(72) Inventors: Vinay SRIDHARA, Sunnyvale, CA (US); Ayman Fawzy NAGUIB, Cupertino, CA (US)

(73) Assignee: QUALCOMM Incorporated, San Diego, CA (US)

(21) Appl. No.: 14/079,447

(22) Filed: Nov. 13, 2013

(51) Int. Cl. H04W 48/20; H04W 24/02; H04L 12/26

(52) U.S. Cl. CPC H04W 48/20; H04L 43/0805; H04W 24/02
USPC 370/252

(57) ABSTRACT

During access point discovery, an initial list of access points available for connection is generated. The received signal strength indication (RSSI) and round trip time (RTT) delay for the access points in the initial list are measured, e.g., during discovery and by a plurality of active measurements. The initial list is pruned based on an initial and subsequent RSSI and RTT measurements to produce a master list of access points. The pruning of the initial list of access points may be based on the differentials in the RSSI measurements and the RTT measurements as well as a determination of access points that the mobile device is moving away from. As the mobile device moves to different locations, access points from the master list may be selected and connected with based on the expected duration of availability as determined by RSSI and RTT measurements.

### BACKGROUND

1. Background Field

The present invention relates generally to selecting and wirelessly connecting to access points with a mobile device and, more particular, to generating a list of access points available for connections based on received signal strength indication (RSSI) and round trip time (RTT) information.

2. Relevant Background

Typically, in order to discover an access point with which to associate, a mobile device will use an active scan or a passive scan. During an active scan, a mobile device transmits a probe request in a specific channel and monitors for probe responses on that channel from access points within range. A probe request must be transmitted and probe response monitored on each channel to discover access points on different channels. Additionally, some access points have hidden SSIDs (service set identifier), particularly in enterprises or secure environments, and accordingly, will not be detected during an active scan. Active scans, however, are inefficient and are generally not useful for discovering access points for positioning, particularly if the channel information of available access points is unknown or the access points do not broadcast their SSIDs. Accordingly, passive scans are typically the preferred access point discovery mechanism.

When a passive scan is used to discover available access points, the mobile device does not transmit probe requests, but instead monitors frames, e.g., Beacon frames, that are transmitted by access points that are within range. Passive scans are useful as the mobile device may identify the SSIDs and channel numbers for all access points that are within radio range, even for access points with hidden SSIDs. Passive scans, however, may consume large amounts of time and power, as the mobile device must dwell on each channel for a period of time while monitoring transmissions on each channel.

While a mobile device is moving, the proper selection of access points for connection is important for seamless connectivity and sustained performance in terms of power and bandwidth utilization. Proper selection of available access points necessarily includes discovering available access points. Discovering available access points may need to be performed often while the mobile device is in motion and, thus, it is desirable for the discovery mechanism to be a power and bandwidth efficient operation.

### SUMMARY

During access point discovery, an initial list of access points available for connection is generated. The received signal strength indication (RSSI) and round trip time (RTT) delay for the access points in the initial list are measured, e.g., during discovery and by a plurality of active measurements. The initial list is pruned based on an initial and subsequent RSSI and RTT measurements to produce a master list of access points. The pruning of the initial list of access points may be based on the differentials in the RSSI measurements and the RTT measurements as well as a determination of access points that the mobile device is moving away from. As the mobile device moves to different locations, access points from the master list may be selected and connected with based on the expected duration of availability as determined by RSSI and RTT measurements.

In one implementation, a method includes generating an initial list of access points that are available for connection at a current location, the initial list of access points comprising an identity of each access point, and connectivity criteria for each access point; performing a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points; pruning the initial list of access points based on the initial RTT measurement, the initial RSSI measurement, the subsequent RTT measurement and the subsequent RSSI measurement to produce a master list of access points; selecting and connecting to a first access point from the master list of access points; and selecting and connecting to a second access point from the master list of access points at a different location.

In one implementation, a mobile device includes a wireless interface to send and receive wireless signals to access points; and a processor coupled to the wireless interface, the processor configured to generate an initial list of access points that are available for connection at a current location, the initial list of access points comprising an identity of each access point, and connectivity criteria for each access point; perform a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points; prune the initial list of access points based on the initial RTT measurement, the initial RSSI measurement, the subsequent RTT measurement and the subsequent RSSI measurement to produce a master list of access points; select and connect to a first access point from the master list of access points; and select and connect to a second access point from the master list of access points at a different location.

In one implementation, a mobile device includes means for generating an initial list of access points that are available for connection at a current location, the initial list of access points comprising an identity of each access point, and connectivity criteria for each access point; means for performing a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points; means for pruning the initial list of access points based on the initial RTT measurement, the initial RSSI measurement, the subsequent RTT measurement and the subsequent RSSI measurement to produce a master list of access points; means for selecting and connecting to a first access point from the master list of access points; and selecting and connecting to a second access point from the master list of access points at a different location.

In one implementation, a non-transitory computer-readable medium including program code stored thereon, includes program code to generate an initial list of access points that are available for connection at a current location, the initial list of access points comprising an identity of each access point, and connectivity criteria for each access point; program code to perform a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points; program code to prune the initial list of access points based on the initial RTT measurement, the initial RSSI measurement, the subsequent RTT measurement and the subsequent RSSI measurement to produce a master list of access points; program code to select and connect to a first access point from the master list of access points; and program code to select and connect to a second access point from the master list of access points at a different location.

### BRIEF DESCRIPTION OF THE DRAWING

FIG. 1 illustrates a block diagram including a mobile device that generates a master list of access points that are available for connection at a current location, which is used for the selection of access points to connect with as the mobile device is moved to different locations.

FIG. 2 is a flow chart illustrating a method performed by the mobile device to discover access points and generate a master list of access points based on RSSI and RTT measurements from which access points are selected as the mobile device is moved to different locations.

FIG. 3 illustrates a graph showing an RSSI curve and an RTT curve as a function of time as measured by a moving mobile device.

FIG. 4 illustrates an indoor environment with a number of access points that are visible to a mobile device, and illustrates various positions of the mobile device as active measurements are performed.

FIG. 5 illustrates an example of an initial list of the access points generated for access points shown in FIG. 4.

FIG. 6 illustrates of a master list of access points generated by pruning the initial list shown in FIG. 5.

FIG. 7 is a block diagram of a mobile device capable of discovering access points and generating a master list of access points based on RSSI and RTT measurements from which access points are selected as the mobile device is moved to different locations.

### DETAILED DESCRIPTION

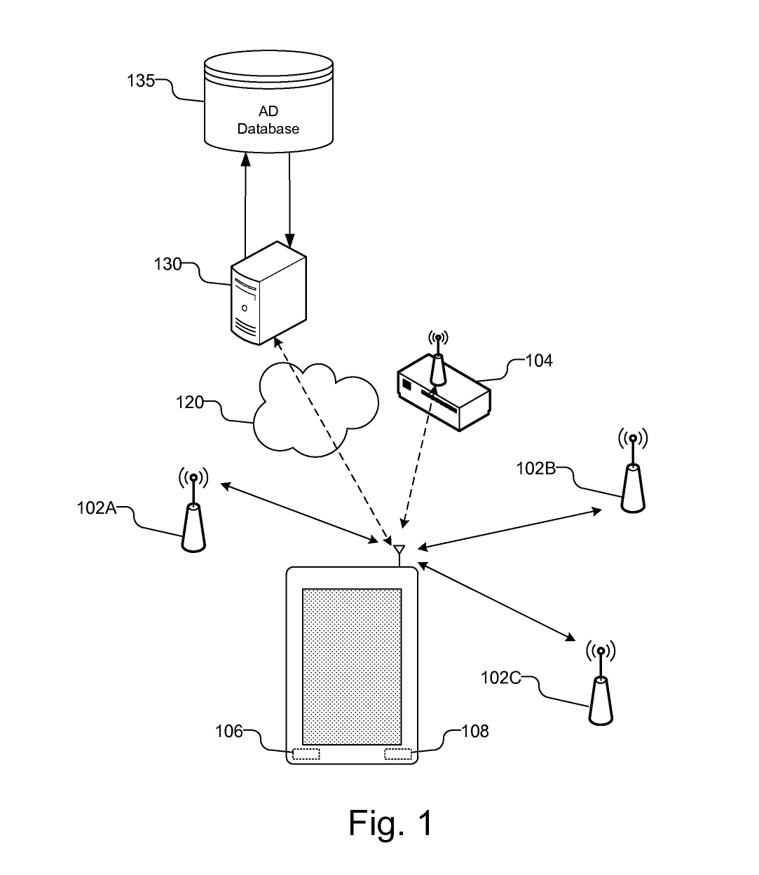

FIG. 1 illustrates a block diagram of a mobile device 100 that generates a master list of access points that are available for connection at a current location, which is used for the selection of access points to connect with as the mobile device is moved to different locations. As illustrated, mobile device 100 is in wireless communication with a number of access points 102A, 102B, and 102C (sometimes collectively referred to as access points 102). The mobile device 100 generates an initial list of access points 102 at its location and uses received signal strength indication (RSSI) measurements and round trip time (RTT) measurements to prune the initial list to produce the master list of access points. The mobile device 100 may then select and connect to access points from the master list as the mobile device 100 moves to different locations. By switching to other access points from the master list as the mobile device 100 moves to different locations, the wireless connection of the mobile device 100 may be optimized, while minimizing the number of passive scans.

Mobile device 100 may discover access points 102 at a current location, e.g., when first performing access point discovery. The access points 102 may be discovered, e.g., by performing a passive scan of available access points 102, or by accessing an assistance data database 135 via server 130 and wireless network 120, as illustrated by the dashed line. The wireless network 120 may be accessed through one of the access points 102 or through other wireless communication means. The assistance data may be the type typically used for indoor location based service (LBS), and may include information that may be used to generate the initial list of access points that are available for connection, such as the identity of each access point (e.g., the Media Access Control (MAC)), and connectivity criteria for each access point (e.g., the Channel, bandwidth, capabilities, etc.).

The mobile device 100 may also connect to and communicate with an access point ensemble controller 104, as illustrated by the dashed line. An access point ensemble controller 104 is typically used in an enterprise environment to connect with and dynamically control the channels of the access points 102, and thus may be referred to herein as a dynamic channel controller. The mobile device 100 may discover the available access points 102 via the access point ensemble controller 104, or may provide connectivity criteria for access points 102 independently discovered by the mobile device 100.

The mobile device 100 may perform an initial pruning of a list of access points obtained by a passive scan or via the assistance data database 135 to produce the initial list of access points. By performing an initial pruning of the access points, e.g., based on connection criteria, the number of active measurements of access points by the mobile device may be greatly reduced.

During an active measurement, the mobile device 100 obtains an RSSI measurement for each access point 102, using an RSSI unit 106. An RSSI measurement may also be obtained, e.g., while performing a passive scan to discover the access points if a passive scan is used to generate the initial list of access points. The mobile device 100 also generates a round trip time (RTT) measurement for each access point on the initial list of access points using an RTT unit 108 during active measurement for each access point. The active measurement for each access point 102 may be a RTT measurement that is typically used for conventional positioning purposes, when the MAC address and the channel of the access point is known. The active measurement returns both the RTT measurement and the RSSI measurement and is performed regardless of whether an RSSI measurement was previously obtained from a passive scan.

The mobile device 100 performs a plurality of active measurements to generate an initial RSSI measurement, an initial RTT measurement, a subsequent RSSI measurement and a subsequent RSSI measurement. For example, a plurality of active measurements may be performed in quick succession, e.g., in the order of few hundred microseconds, to produce the initial RSSI measurement and initial RTT measurement. The RTT measurements obtained in the plurality of active measurements performed in quick succession may be averaged, and similarly RSSI measurements may be averaged to produce the initial RSSI measurement and initial RTT measurement. The quick succession of the plurality of active measurements ensures that the averaging is achieved with the user approximately at the same location. The subsequent RSSI measurement and subsequent RTT measurement may be similarly produced, e.g., several seconds after the initial RSSI measurement and initial RTT measurement are produced.

The mobile device 100 prunes the initial list of access points based on the initial RTT measurement, the initial RSSI measurement, the subsequent RTT measurement and the subsequent RSSI measurement to produce the master list of access points. The mobile device 100 may then select and connect to an appropriate access point 102 from the master list of access points. By way of example, the initial and subsequent RSSI measurements and RTT measurements may be used to determine which access point 102 will be available for connection to the mobile device 100 the longest while the mobile device 100 is moving. After moving to a different location (at which the access points 102 in the master list of access points are still visible to the mobile device 100), the mobile device 100 may select and connect to a different access point from the master list of access points, e.g., based on criteria such as additional RSSI and RTT measurements and predicted duration of availability for connection at the new location, which may be determined from additional active measurements of the access points of the master list in different locations. Thus, the need to generate new lists of access points, e.g., using passive scans, as the mobile device 100 moves to different locations is minimized.

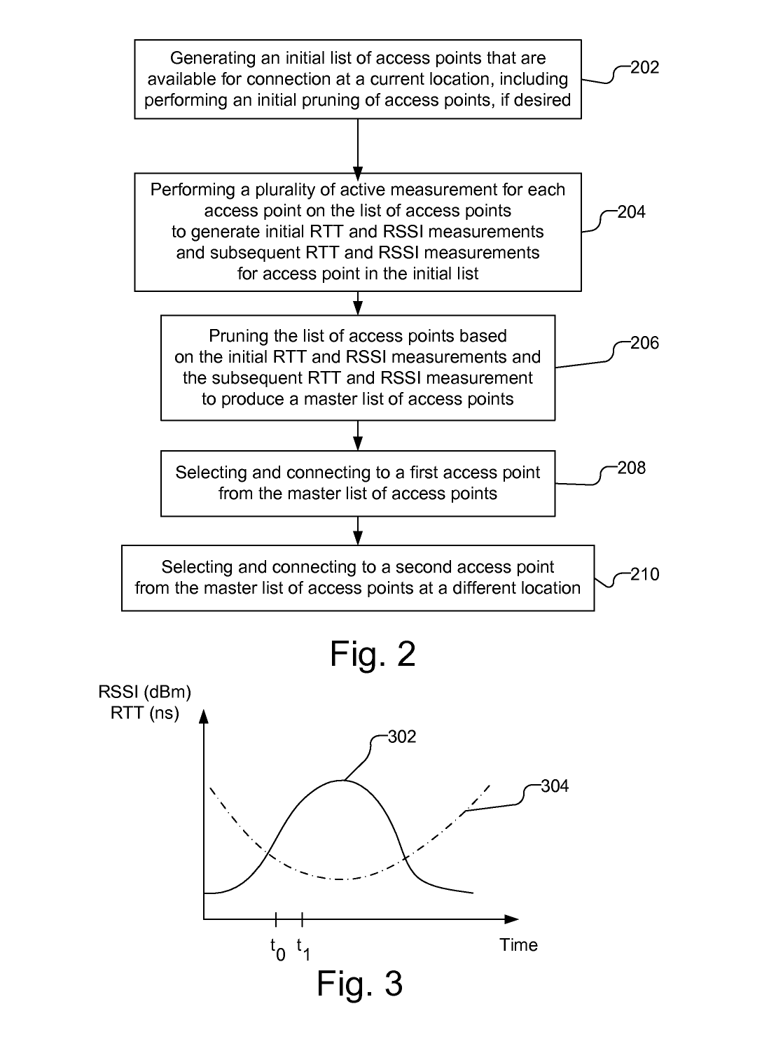

FIG. 2 is a flow chart illustrating a method performed by the mobile device 100 to discover access points and generate a master list of access points based on RSSI and RTT measurements from which access points are selected as the mobile device 100 is moved to different locations. As illustrated, an initial list of access points that are available for connection at a current location is generated (202). The initial list of access points includes an identity and connectivity criteria for each access point. The initial list of access points may be generated by performing a passive scan. The initial list of access points may be generated also or alternatively by connecting to a server to obtain assistance data that includes the identities of the access points that are typically used for indoor location based service (LBS) at the current location. For example, LCI (Location Context Identifier: e.g. Floor of a building) disambiguation capability of the LBS system can be utilized to generate a list of access points.

If the channel of the access points 102 are dynamically controlled, the mobile device 100 may connect to an access point ensemble controller 104 that is coupled to the access points 102 and generate the initial list of access points or connectivity criteria, such as channel information for the access points from the access point ensemble controller 104. Additionally, the initial list of access points may be generated with a neighbor report type of messaging, e.g., 802.11v, in which access points scan the surrounding access points as well as the traffic and report this as an Information Element in a Beacon message.

If desired, the initial list of access points may be generated by performing an initial pruning of a list of available access points (202), e.g., based on RSSI measurements from a passive scan, or other desired criteria, such as connectivity criteria. Performing an initial pruning of access points to generate the initial list of access points ensures that active measurements are performed on only access points that have satisfied a desired connectivity criteria, e.g. 802.11a/b/g/n/ac/ad standard, 20/40/80 MHz bandwidth, 802.11u/v etc. capability etc. For example, the initial pruning may be performed based on the standard supported by the access points, the make/manufacture of the access point (for example, some manufactured access points are known to not prove consistent RTT measurements), the chipset used by the access points (this information may be available through some list provided by the service provider).

Once the initial list of available access points is generated, the mobile device 100 may perform a plurality of active measurements for each access point on the initial list of access points to an initial round trip time (RTT) measurement, an initial received signal strength indication (RSSI) measurement, a subsequent RTT measurement, and a subsequent RSSI measurement for each access point in the initial list of access points (204). The active measurements may be the type of measurements used conventionally for positioning purposes, when the MAC address and the channel of the access point is known. It should be understood, however, that the active measurements is not being used for positioning purposes here, but rather is used to assist in access point connectivity decisions. The active measurements may return both RTT measurements and RSSI measurements for each access point. If an RSSI measurement was produced during a passive scan to generate the initial list of access points, that RSSI measurement may be used with one or more RSSI measurements from active measurements to produce the initial RSSI measurement. If desired, mobile device 100 may perform a first plurality of active measurements to generate the initial RTT measurement and the initial RSSI measurement and perform a second plurality of active measurements to generate the subsequent RTT measurement and the subsequent RSSI measurement. For example, the first plurality of active measurements may be performed in quick succession, e.g., in the order of few hundred microseconds, thereby producing a plurality of RSSI measurements and RTT measurements. The RTT measurements may be averaged (or otherwise combined) to produce the initial RTT measurement and the plurality of RSSI measurements may be averaged (or otherwise combined) to produce the initial RSSI measurement. The quick succession of the plurality of active measurements ensures that the plurality of RTT and the plurality of RSSI measurements are produced with the mobile device 100 at approximately the same location. The subsequent RSSI measurement and subsequent RTT measurement may be similarly produced, e.g., using a plurality of active measurements performed in quick succession. The subsequent RSSI measurement and subsequent RTT measurement, however, are generated, e.g., several seconds after the initial RSSI measurement and initial RTT measurement. The delay between the initial and subsequent RSSI and RTT measurements should be sufficient to produce a difference in the initial and subsequent measurements due to movement of the mobile device 100.

The initial list of access points is pruned based on the initial RTT measurement, the initial RSSI measurement, the subsequent RTT measurement and the subsequent RSSI measurement (206) to produce a master list of access points.

FIG. 3, by way of example, illustrates a graph showing an RSSI curve 302 and an RTT curve 304 as a function of time, as measured by a mobile device moving in a linear direction with respect to an access point. As can be seen in FIG. 3, the RSSI measurements will typically increase over time as the mobile device is moving towards the access point, then decrease when the mobile device passes and moves away from the access point. Conversely, the RTT measurement will typically decrease as the mobile device moves towards the access point, then increase as the mobile device passes and moves away from the access point. Thus, assuming the mobile device is moving generally towards the access point, an initial active measurement (or plurality of active measurements in quick succession) at time t₀ will produce an initial RSSI measurement that will be less than a subsequent RSSI measurement from a subsequent active measurement at time t₁. Conversely, the initial active measurement at time t₀ will produce an initial RTT measurement that will be larger than a subsequent RTT measurement from a subsequent active measurement at time t₁. If the mobile device is moving away from the access points, the initial RSSI measurement will be greater than a subsequent RSSI measurement, and the initial RTT measurement will be less than a subsequent RTT measurement.

Consequently, using the initial RTT measurement, the initial RSSI measurement, the subsequent RTT measurement and the subsequent RSSI measurement, the mobile device 100 can determine with high probability if the mobile device is moving towards or away from an access point, a change in the RSSI and RTT measurements, the rate of change in the RSSI and RTT measurements, an estimated distance to the access point, and a rate of change in the estimated distance to the access point. One or more of these factors may be considered in pruning the initial list of access points. For example, generally, access points that mobile device is moving away from may be pruned, unless, e.g., the access point is significantly closer than other access points. The initial list of access points may be pruned based on the distance to access points or the rate of change in the distance to access points as distant access points are less likely to be used for connectivity by the mobile device (particularly if the mobile device is moving away from the access point). Further, the rate of change in the RSSI and RTT measurements can provide additional useful information, such as whether the access point is near the direction of travel of the mobile device. These factors may provide relative information and/or threshold may be applied to determine which access points to remove from the initial list to produce the master list.

If desired, inertial sensors, e.g., accelerometers, gyroscopes, etc., on the mobile device 100 may be used to determine when the mobile device 100 has moved to ensure that the additional active measurements are performed after movement of the mobile device 100. Alternatively, if the initial and subsequent measurements do not have a significant change, e.g., the difference is less than a threshold, it may be assumed that the mobile device 100 is not moving, and pruning of the initial list of access points may be delayed until a subsequent active measurement is performed that results in significantly different RSSI and RTT measurements.

By way of example of the use of the initial RTT measurement, the initial RSSI measurement, the subsequent RTT measurement and the subsequent RSSI measurement, an RTT differential, e.g., the change (or rate of change) in RTT measurement with respect to time, may be computed using the initial RTT measurement and the subsequent RTT measurement, and an RSSI differential, e.g., the change (or rate of change) in the RSSI measurement with respect to time, may be computed using the initial RSSI measurement and the subsequent RSSI measurement for each access point. The comparison of the initial and subsequent RSSI and RTT measurements provides information about whether the mobile device is moving towards or away from the access point, which can used to prune the initial list of access points. Additionally, the initial list of access points may be pruned based on the RTT differential and the RSSI differential. The RTT differential and the RSSI differential may be used, e.g., as variables for estimating the change (or rate of change) in the distance to an access point with respect to time. Thus, for example, if an access point is visible in the initial active measurement with very low RSSI value or with a very high RTT value, and in the subsequent active measurements, the RSSI value increases and the RTT value decreases, then it may be determined that the access point will be visible with higher probability for a long duration.

Additionally, or alternatively, an initial estimated distance may be calculated using the initial RTT measurement and the initial RSSI measurement and a subsequent estimated distance may be calculated using the subsequent RTT measurement and the subsequent RSSI measurement for each access point. A distance differential, the change (or rate of change) in the estimated distance with respect to time, may be computed with initial estimated distance and the subsequent estimated distance for each access point and the initial list of access points may be pruned based on the distance differential.

For example, after the active measurement of an access point k, the mobile device 100 uses the RSSI measurement to produce an estimate for the distance d_{RSSI,k} to the access point k along with the variance σ²_{dRSSI,k}:

d_{RSSI,k}=f_{d}(RSSIₖ)

σ²_{d}_{_{RSSI,k}}=f_{σ}_{²}(RSSIₖ). eq. 1

The mobile device 100 may estimate the mean and variance of the RSSI noise nₖ. If the mobile device 100 has knowledge of the RSSI noise, it can estimate the mean μₙ_{ₖ} and the variance \hat{σ}_{n,k}² as:

μ_{n,k}=μ_{n,k}(d_{RSSI,k})

\hat{σ}_{n,k}²=σ²_{n,k}(d_{RSSI,k}+2σ_{d}_{_{RSSI,k}}), eq. 2

where the mobile device adds 2σ_{d}_{_{RSSI,k}} to take a more conservative estimate of the RSSI noise variance. In the more common case, where the mobile device 100 does not know the RSSI noise statistics, it may use \hat{μ}_{n,k}=0 and a worst case \hat{σ}_{n,k}² such as 50².

Additionally, the mobile device 100 may use the average of mₖ RTT measurements to produce another estimate for the distance d_{RTT,k} to the access point k along with the variance σ²_{dRTT,k}:

$${d}_{RTT , k} = \frac{\overline{{RTT}_{k}} - {\hat{Δ}}_{k} - {\hat{μ}}_{n , k}}{2} \\ {σ}_{{d}_{RTT , k}}^{2} = \frac{{σ}_{\hat{Δ} , k}^{2} + {\hat{σ}}_{n , k}^{2} / {m}_{k}}{4} . \qquad eq . 3$$

where \hat{Δ}ₖ is the processing delay for RTT estimation, which may be the fixed time that the AP waits before responding to an RTT request.

The mobile device 100 may truncate d_{RTT,k} if necessary to fall between 0 and the maximum access point range. The estimated distances from the RSSI and RTT measurements may then be combined, e.g., using a Minimum Mean Square Error (MMSE) estimator to yield an estimated distance, e.g.,:

$${d}_{est , k} = ( \frac{{σ}_{{d}_{RSSI , k}}^{- 2}}{{σ}_{{d}_{RSSI , k}}^{- 2} + {σ}_{{d}_{RTT , k}}^{- 2}} ) {d}_{RSSI , k} + ( \frac{{σ}_{{d}_{RTT , k}}^{- 2}}{{σ}_{{d}_{RSSI , k}}^{- 2} + {σ}_{{d}_{RTT , k}}^{- 2}} ) {d}_{RTT , k} \qquad eq . 4$$

With a variance of:

σ²_{d}_{_{est,k}}=(σ⁻²_{d}_{_{RSSI,k}}+σ⁻²_{d}_{_{RTT,k}})⁻¹ eq. 5

Assuming the RSSI and RTT noise can be modeled as uncorrelated and Gaussian.

The distance estimator relies on RSSI when σ_{d}_{_{RTT}}_{,k}² is large, either from uncertainty in the processing delay or very noisy RTT measurements. However, once the processing delay is known (low σ_{Â,k}²) the estimator puts more weight on the RTT measurements.

Of course, other techniques may be used to estimate a distance to each access point, e.g., using weighted averaging of the RTT and RSSI derived distances.

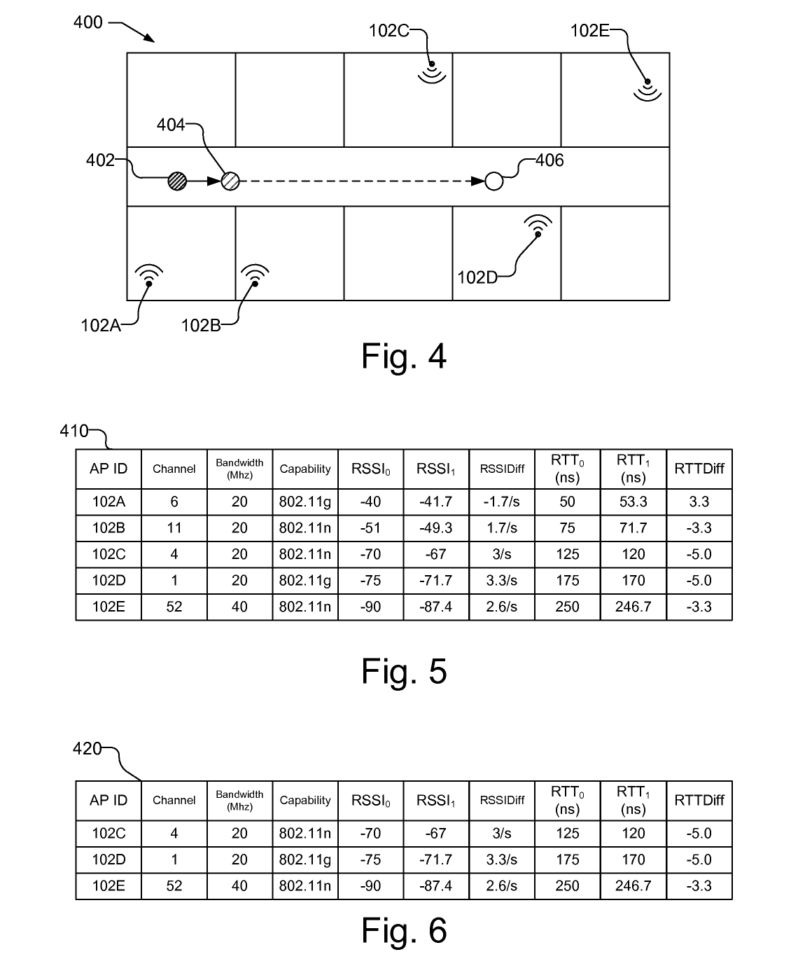

By way of example, FIG. 4 illustrates an indoor environment 400 with a number of access points 102A, 102B, 102C, 102D, and 102E that are visible to a mobile device, and illustrates the position 402 of the mobile device at a first location within the environment 400. While at the first location 402, the mobile device generates an initial list 410 of the access points, e.g., using a passive scan, illustrated in FIG. 5. The mobile device may perform an initial scan of the visible access points to produce the initial list. The mobile device performs an initial active measurement of the access points on the initial list 410 to obtain an initial RTT measurement (RTT₀) and initial RSSI (RSSI₀) measurement for the access points. The initial list 410 includes an identifier of the access point (AP ID), which is illustrated in FIG. 5 as the reference numbers from FIG. 4, but may be the MAC address of the access point. The initial list 410 further includes connectivity criteria, such as the channel, bandwidth and capabilities of the access points, as well as the measured RSSI values and RTT values. The mobile device performs a subsequent active measurement after the initial active measurement, e.g., after the mobile device has moved slightly illustrated as position 404 in FIG. 4, to produce a subsequent RTT measurement (RTT₁) and subsequent RSSI (RSSI₁) measurement for the access points. As illustrated in FIG. 4, the RSSI differential (RSSIDiff) and RTT differential (RTTDiff) may be calculated. Additional factors, such as the estimated distances, rate of change of the distance, etc. may also be determined. The initial list 410 of access points may then be pruned based on the initial RTT measurement, the initial RSSI measurement, the subsequent RTT measurement and the subsequent RSSI measurement to produce a master list 420 of access points, illustrated in FIG. 6. As can be seen by comparing FIGS. 5 and 6, access point 102A has been pruned as the mobile device is moving away from it. Additionally, access point 102B has been pruned based on the RSSI and RTT measurements as the length of time that the access points may be visible to the mobile device (e.g., determined by the RSSI differential and RTT differential) is less than access points 102C, 102D, and 102E.

It should be noted that it may be undesirable to use RTT measurements from access points with software MAC addresses from the initial list of access points, as access points with software MAC address have a relatively unstable response delay in RTT measurements. As is well known, RTT measurements are generated by transmitting a request and determining the time until a response is received. The delay between the request and the response, however, is a variable with an uncertainty of ±900 ns. Access points with hardware MAC addresses, however, have a relatively stable response delay, while the response delay of access points with software MACs addresses is more inconsistent. A variation in the RTT measurement results over short periods of time (less than a few seconds) may be used to predict whether the access point has a hardware MAC address or a software MAC address. Accordingly, a plurality of initial active measurements for each access point may be performed to generate multiple RTT measurements over a short period of time for each access point. The variation in the response delay in the RTT measurements is determined for each access point, which may be used to predict whether each access point has a hardware MAC address or a software MAC address. Any RTT measurements associated with access points with hardware MAC addresses may be used for pruning the initial list of access points, while RTT measurements associated with access points with software MAC addresses are not used for pruning the initial list of access points.

Thus, as can be seen in FIGS. 4 and 5, the initial list of access points may be pruned, e.g., based the initial RTT measurement, the initial RSSI measurement, the subsequent RTT measurement and the subsequent RSSI measurement, which may provide a measure, e.g., the relative length of time that the access points may be visible to the mobile device 100. For example, access points that the mobile device 100 is moving away from will be available to the mobile device 100 for relatively less time than access points that the mobile device 100 is moving towards, as determined from successive active measurements, and thus, may be pruned from the initial list of access points. Moreover, an access point that is near the mobile device 100 during discovery may be available to the mobile device 100 for relatively less time than an access point that is relatively far from the mobile device 100, which may be determined from a differential RSSI measurement and a differential RTT measurement, assuming the mobile device is moving towards both access points. The change in RSSI and RTT for each access point may be compared to the change in RSSI and RTT for other visible access points. If desired, the change in RSSI and RTT may include additional active measurements than the initial and subsequent active measurements, and thus may include a measurement history, e.g., the last 15 seconds. Additionally, the velocity of the mobile device, e.g., the use's walking speed, may be obtained. For example, the velocity of the mobile device may be determined from sensors on the mobile device or from the rate of change of RSSI or RTT or a combination of rate of change of RSSI and RTT. The velocity of the mobile device may be used to determine whether the mobile device is not moving and pruning of the initial list of access points should be delayed until subsequent active measurements can be performed that will result in significantly different RSSI and RTT measurements.

Returning to FIG. 2, once the initial list of access points is pruned to produce the master list of access points, an access point from the master list is selected and connected to (208). The selection of the access point may be based on the expected longevity of the connection, e.g., based on the initial RTT measurement, the initial RSSI measurement, the subsequent RTT measurement and the subsequent RSSI measurement, whether the mobile device is moving towards or away from an access point, the rate of change of RSSI and/or RTT and/or estimated distance to an access point, etc., as well as other desired connectivity criteria, such as the bandwidth. In other words, the selection of the access point may be based at least partially on the RTT differential and the RSSI differential and/or based on the distance differential. For example, referring to the master list 420 shown in FIG. 6, the access point 102C may be selected for connection based on the differential between the RSSI measurements and the RTT measurements or the estimated distance determined from the RSSI measurements and the RTT measurements. Additionally, the selection may be dictated by other factors, such as the application running on the mobile device. For example, if a high definition video is running on the mobile device, then it may be desirable to optimize bandwidth and connection time, whereas if a webpage is being displayed on the mobile device, the connection establishment time is not as important as the instantaneous bandwidth, as well as power savings.

After moving to a different location, a second access point from the master list of access points is selected and connected to (210). Thus, once connected to an access point, the master list of access points may be periodically updated by performing active measurements of the access points on the master list to generate current RTT measurements and RSSI measurements for the access point on the master list. Updating may be performed, e.g., when the strength of signals received from the access point to which the mobile device is connected decreases by a threshold or after set period of time, e.g., 10 s, 30 s, 1 min, etc., or may be a function of factors such as the determined velocity of the mobile device or density of access point. The differential RSSI and differential RTT measurements and/or differential distance measurement, for example, may be continually updated at each periodic active measurement for the access points on the master list and used to determine when to switch connection to the second (different) access point. Additionally, the updated RTT measurements and RSSI measurements may be used to determine which access points are being moved towards and which are being moved away from by the mobile device, as discussed above. The decision to switch connection to a different access point may be weighted by the duration of the last connection and the expected longevity of the current connection, which may be determined over a period of time. Moreover, if desired, the master list may be further pruned based on the updated RTT measurements and RSSI measurements, e.g., to remove access points that the mobile device is moving away from.

By way of example, the master list 420 shown in FIG. 5 may be updated when the mobile device is at position 406 shown in FIG. 4. Based on new RSSI and RTT values from the active measurement, e.g., to update the differential RSSI and differential RTT measurements and/or differential distance measurement, a different access point, e.g., access point 102e, may be selected when the mobile device 100 is at position 406 based on the expected longevity of the connection. The update to the differential RSSI and differential RTT measurements and/or differential distance measurement may be, e.g., a running average, if desired.

With the master list of access points generated during the initial discover and connection phase, power and time consuming passive scans may be avoided as long as the master list of access points includes an adequate number of access points that are still providing RTT and RSSI values from the active measurements. Moreover, the number of active measurements performed by the mobile device 100 is reduced to only the number of access points on the master list of access points.

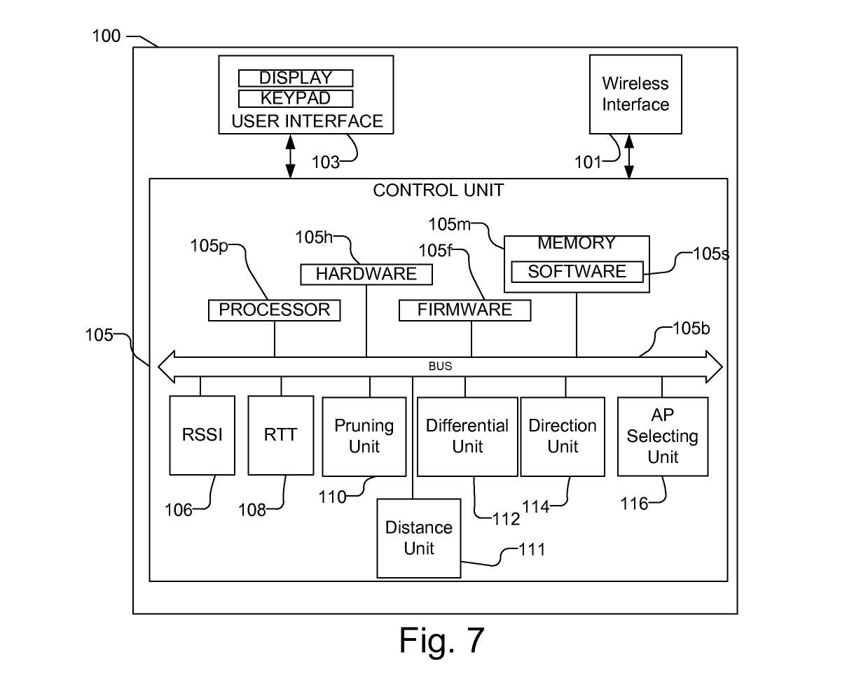

FIG. 7 is a block diagram of a mobile device 100 capable of discovering access points and generating a master list of access points based on an initial RTT measurement, an initial RSSI measurement, a subsequent RTT measurement and a subsequent RSSI measurement, and selecting access points from the master list as the mobile device 100 is moved to different locations. The mobile device 100 includes a wireless interface 101 that may be used to wirelessly communicate with access points 102, the access point ensemble controller 104, and remote server 130 to generate the initial list of access points, as well as to perform the active measurements of the access points. The mobile device 100 may further include a user interface 103 that may include e.g., a display, as well as a keypad or other input device through which the user can input information into the mobile device 100.

The wireless interface 101 may be used in any various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. Moreover, any combination of WWAN, WLAN and/or WPAN may be used.

The mobile device 100 also includes a control unit 105 that is connected to and communicates with the wireless interface 101. The control unit 105 accepts and processes data obtained from wireless interface 101 and causes the wireless interface 101 to transmit signals for active measurements, e.g., to measure the RTT delay, as well as connect to the access point ensemble controller 104 and/or remote server 130 as necessary. The control unit 105 may be provided by a bus 105b, processor 105p and associated memory 105m, hardware 105h, firmware 105f, and software 105s. The control unit 105 further includes the RSSI unit 106 to measure the strength of signals received by the wireless interface and the RTT unit 108 to measure the round trip time delay between the mobile device and access points. The control unit 105 further includes a pruning unit 110 that prunes the initial list of access points based on the initial RTT measurement, the initial RSSI measurement, the subsequent RTT measurement and the subsequent RSSI measurement to produce a master list of access points. The control unit 105 may further include distance unit 111 to determine an estimated distance to the access points, a differential unit 112 to determine the differential RSSI measurement, the differential RTT measurement, and a differential distance measurement, and a direction unit 114 to determine whether the mobile device 100 is moving towards or away from access points based on successive active measurements. An access point selecting unit 116 is included to select which access points to connect to from the master list of access points as well as when to switch connection to different access points on the master list.

The various units 106, 108, 110, 111, 112, 114, and 116 are illustrated separately from processor 105p for clarity, but may be part of the processor 105p or implemented in the processor based on instructions in the software 105s which is run in the processor 105p. It will be understood as used herein that the processor 105p can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The methodologies described herein may be implemented by various means depending upon the application. For example, these methodologies may be implemented in hardware 105h, firmware 105f, software 105s, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 105m and executed by the processor 105p. Memory 105m may be implemented within or external to the processor 105p. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Thus, the mobile device 100 includes a means for generating an initial list of access points that are available for connection at a current location, which may be, e.g., the wireless interface 101. A means for performing a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points may be, e.g., the RSSI unit 106 and the RTT unit 108. A means for pruning the initial list of access points based on the initial RTT measurement, the initial RSSI measurement, the subsequent RTT measurement and the subsequent RSSI measurement to produce a master list of access points may be, e.g., the pruning unit 110. A means for selecting and connecting to a first access point from the master list of access points may be, e.g., the AP selecting unit 116. Additionally, a means for selecting and connecting to a second access point from the master list of access points at a different location may be, e.g., the AP selecting unit 116. The mobile device 100 may further include a means for computing an RTT differential of the initial RTT measurement and the subsequent RTT measurement and an RSSI differential of the initial RSSI measurement and the subsequent RSSI measurement for each access point, which may be the differential unit 112. A means for computing an initial estimated distance using the initial RTT measurement and the initial RSSI measurement and a subsequent estimated distance using the subsequent RTT measurement and the subsequent RSSI measurement for each access point may be the distance unit 111 and a means for computing a distance differential of the initial estimated distance and the subsequent estimated distance for each access point may be the differential unit 112. A means for determining which access points are being moved away from using the active measurement and a second active measurement may be, e.g., the direction unit 114.

Although various aspects of the invention are illustrated in connection with specific embodiments for instructional purposes, various aspects of the invention are not limited thereto. Various adaptations and modifications may be made without departing from the scope of the invention. Therefore, the spirit and scope of the appended claims should not be limited to the foregoing description.

What is claimed is:

1. A method of connecting to access points comprising:
generating an initial list of access points that are available for connection at a current location, the initial list of access points comprising an identity of each access point, and connectivity criteria for each access point;
performing a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points;
pruning the initial list of access points based on the initial RTT measurement, the initial RSSI measurement, the subsequent RTT measurement and the subsequent RSSI measurement to produce a master list of access points;
selecting and connecting to a first access point from the master list of access points; and
selecting and connecting to a second access point from the master list of access points at a different location.

2. The method of claim 1, wherein performing the plurality of active measurements for each access point comprises performing a first plurality of active measurements to generate the initial RTT measurement and the initial RSSI measurement, and performing a second plurality of active measurements to generate the subsequent RTT measurement and the subsequent RSSI measurement.

3. The method of claim 2, further comprising:
performing a first plurality of RTT measurements to generate the initial RTT measurement for each access point;
determining a variation in the RTT measurements for each access point;
determining whether a Media Access Control (MAC) address for each access point is a hardware MAC address or a software MAC address based on the variation in the RTT measurements; and
using RTT measurements only from access points with hardware MAC addresses for pruning the initial list of access points.

4. The method of claim 1, wherein generating the initial list of access points comprises performing a first pruning of access points based on the connectivity criteria before performing the plurality of active measurements.

5. The method of claim 1, wherein generating the initial list of access points that are available for connection at the current location comprises performing a passive scan to identify access points.

6. The method of claim 5, wherein performing the passive scan produces an RSSI measurement for each access point that is used to produce the initial RSSI measurement.

7. The method of claim 1, wherein generating the initial list of access points that are available for connection at the current location comprises connecting to a server to obtain assistance data that includes identities of access points for location based service for the current location.

8. The method of claim 1, wherein pruning the initial list of access points comprises:
computing an RTT differential of the initial RTT measurement and the subsequent RTT measurement and an RSSI differential of the initial RSSI measurement and the subsequent RSSI measurement for each access point; and
pruning the initial list of access points based on the RTT differential and the RSSI differential.

9. The method of claim 8, wherein selecting and connecting to the first access point from the master list of access points comprises selecting the first access point from the master list of access points based on the RTT differential and the RSSI differential.

10. The method of claim 1, wherein pruning the initial list of access points comprises:
computing an initial estimated distance using the initial RTT measurement and the initial RSSI measurement and a subsequent estimated distance using the subsequent RTT measurement and the subsequent RSSI measurement for each access point;
computing a distance differential of the initial estimated distance and the subsequent estimated distance for each access point; and
pruning the initial list of access points based on the distance differential.

11. The method of claim 10, wherein selecting and connecting to the first access point from the master list of access points comprises selecting the first access point from the master list of access points based on the distance differential.

12. The method of claim 1, wherein pruning the initial list of access points comprises:
determining which access points are being moved away from using the plurality of active measurements; and
pruning the initial list of access points to remove access points that are being moved away from.

13. The method of claim 1, wherein selecting and connecting to the second access point from the master list of access points at the different location comprises:
performing periodic active measurements for each access point on the master list of access points to periodically generate additional RTT measurements and RSSI measurements for each access point after connecting to the first access point; and
using the additional RTT measurements and RSSI measurements to determine to switch connection to the second access point.

14. A mobile device that connects to access points, the mobile device comprising:
a wireless interface to send and receive wireless signals to access points; and
a processor coupled to the wireless interface, the processor configured to generate an initial list of access points that are available for connection at a current location, the initial list of access points comprising an identity of each access point, and connectivity criteria for each access point; perform a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points; prune the initial list of access points based on the initial RTT measurement, the initial RSSI measurement, the subsequent RTT measurement and the subsequent RSSI measurement to produce a master list of access points; select and connect to a first access point from the master list of access points; and select and connect to a second access point from the master list of access points at a different location.

15. The mobile device of claim 14, wherein the processor is configured to perform the plurality of active measurements for each access point by being configured to perform a first plurality of active measurements to generate the initial RTT measurement and the initial RSSI measurement, and perform a second plurality of active measurements to generate the subsequent RTT measurement and the subsequent RSSI measurement.

16. The mobile device of claim 15, herein the processor is configured to perform a first plurality of RTT measurements to generate the initial RTT measurement for each access point; determine a variation in the RTT measurements for each access point, determine whether a Media Access Control (MAC) address for each access point is a hardware MAC address or a software MAC address based on the variation in the RTT measurements; and use RTT measurements only from access points with hardware MAC addresses for pruning the initial list of access points.

17. The mobile device of claim 14, wherein the processor is configured to generate the initial list of access points by being configured to perform a first pruning of access points based on the connectivity criteria before performing the plurality of active measurements.

18. The mobile device of claim 14, wherein the processor is configured to generate the initial list of access points by being configured to perform a passive scan to identify access points.

19. The mobile device of claim 18, wherein the passive scan produces an RSSI measurement for each access point that is used to produce the initial RSSI measurement.

20. The mobile device of claim 14, wherein the processor is configured to generate the initial list of access points by being configured to connect to a server to obtain assistance data that includes identities of access points for location based service for the current location.

21. The mobile device of claim 14, wherein the processor is configured to prune the initial list of access points by being configured to compute an RTT differential of the initial RTT measurement and the subsequent RTT measurement and an RSSI differential of the initial RSSI measurement and the subsequent RSSI measurement for each access point; and prune the initial list of access points based on the RTT differential and the RSSI differential.

22. The mobile device of claim 21, wherein the processor is configured to select and connect to the first access point from the master list of access points by being configured to select the first access point from the master list of access points based on the RTT differential and the RSSI differential.

23. The mobile device of claim 14, wherein the processor is configured to prune the initial list of access points by being configured to compute an initial estimated distance using the initial RTT measurement and the initial RSSI measurement and a subsequent estimated distance using the subsequent RTT measurement and the subsequent RSSI measurement for each access point; compute a distance differential of the initial estimated distance and the subsequent estimated distance for each access point; and prune the initial list of access points based on the distance differential.

24. The mobile device of claim 23, wherein the processor is configured to select and connect to the first access point from the master list of access points by being configured to select the first access point from the master list of access points based on the distance differential.

25. The mobile device of claim 14, wherein the processor is configured to prune the initial list of access points by being configured to determining which access points are being moved away from using the plurality of active measurements; and prune the initial list of access points to remove access points that are being moved away from.

26. The mobile device of claim 14, wherein the processor is configured to select and connect to the second access point from the master list of access points at the different location by being configured to perform periodic active measurements for each access point on the master list of access points to periodically generate additional RTT measurements and RSSI measurements for each access point after connecting to the first access point; and use the additional RTT measurements and RSSI measurements to determine to switch connection to the second access point.

27. A mobile device that connects to access points, the mobile device comprising:
means for generating an initial list of access points that are available for connection at a current location, the initial list of access points comprising an identity of each access point, and connectivity criteria for each access point;
means for performing a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points;
means for pruning the initial list of access points based on the initial RTT measurement, the initial RSSI measurement, the subsequent RTT measurement and the subsequent RSSI measurement to produce a master list of access points;
means for selecting and connecting to a first access point from the master list of access points; and
selecting and connecting to a second access point from the master list of access points at a different location.

28. The mobile device of claim 27, wherein the means for pruning the initial list of access points comprises:
means for computing an RTT differential of the initial RTT measurement and the subsequent RTT measurement and an RSSI differential of the initial RSSI measurement and the subsequent RSSI measurement for each access point; and
wherein the means for pruning the initial list of access points uses the RTT differential and the RSSI differential.

29. A non-transitory computer-readable medium including program code stored thereon for connecting to access points, comprising:
program code to generate an initial list of access points that are available for connection at a current location, the initial list of access points comprising an identity of each access point, and connectivity criteria for each access point;
program code to perform a plurality of active measurements for each access point on the initial list of access points to generate an initial round trip time (RTT) measurement, an initial received signal strength indication (RSSI) measurement, a subsequent RTT measurement, and a subsequent RSSI measurement for each access point in the initial list of access points;
program code to prune the initial list of access points based on the initial RTT measurement, the initial RSSI measurement, the subsequent RTT measurement and the subsequent RSSI measurement to produce a master list of access points;
program code to select and connect to a first access point from the master list of access points; and
program code to select and connect to a second access point from the master list of access points at a different location.

30. The non-transitory computer-readable medium of claim 29, wherein the program code to prune the initial list of access points comprises:
program code to compute an RTT differential of the initial RTT measurement and the subsequent RTT measurement and an RSSI differential of the initial RSSI measurement and the subsequent RSSI measurement for each access point; and
program code to prune the initial list of access points based on the RTT differential and the RSSI differential.
